(19) United States
(12) Patent Application Publication
(10) Pub. No.: US 2022/0113049 A1
(43) Pub. Date: Apr. 14, 2022

(54) AUTONOMOUS CONTROL OF SUPERVISORY SETPOINTS USING ARTIFICIAL INTELLIGENCE

(71) Applicant: Microsoft Technology Licensing, LLC, Redmond, WA (US)

(72) Inventors: Kingsuk MAITRA, Milpitas, CA (US); Hossein KHADIVI HERIS, El Cerrito, CA (US)

(21) Appl. No.: 17/132,321

(22) Filed: Dec. 23, 2020

Related U.S. Application Data
(60) Provisional application No. 63/091,384, filed on Oct. 14, 2020.

(51) Int. Cl. F24F 11/63; F24F 11/30; G06N 3/08; G06K 9/62

(52) U.S. Cl. CPC F24F 11/63; G06K 9/6257; G06N 3/08; F24F 11/30

(57) ABSTRACT

Systems and methods related to autonomous control of supervisory setpoints using artificial intelligence are described. In one example, a method including using a measurable attribute associated with a system, segmenting operational data associated with the system into at least a first bin and a second bin, is provided. The method further includes training a first brain based on a first data model associated with the first bin and training a second brain based on a second data model associated with the second bin. The method further includes using the first brain and the second brain, implemented by at least one processor, automatically generating predicted supervisory control suggestions for a plurality of supervisory setpoints associated with the system.

### CROSS REFERENCE TO A RELATED APPLICATION

This application claims the benefit of U.S. Provisional Application No. 63/091,384, filed Oct. 14, 2020, entitled “AUTONOMOUS CONTROL OF SUPERVISORY SETPOINTS USING ARTIFICIAL INTELLIGENCE,” the entire contents of which is hereby incorporated herein by reference.

### BACKGROUND

Control systems used for controlling heating, cooling, or other types of variables include complicated lower level control mechanisms. Often these complicated lower level control mechanisms are calibrated and set by technicians responsible for the maintenance of the control systems. The settings for the low level controls based on such calibrations may not result in an efficient operation because of the variable demands on the systems being controlled or the unexpected changes in the operating environment of the systems being controlled.

Moreover, not only do the control systems have to comply with safety and security measures, but they must also comply with regulatory frameworks, including environmental regulations. Effective control of the systems in an uncertain operating environment and a rapidly changing regulatory framework requires continued improvements to the systems and methods used for controlling such systems.

### SUMMARY

In one example, the present disclosure relates to autonomous control of supervisory setpoints using artificial intelligence. An example method includes collecting historical and state data associated with a system (e.g., a heating, ventilation, and cooling (HVAC) system. The collected data may be filtered and rearranged, as needed, to create operational data. The method may further include using a measurable attribute associated with the system, segmenting the operational data into a first bin, a second bin, a third bin, and a fourth bin. The method may further include preparing a first data model associated with the first bin, a second data model associated with the second bin, a third data model associated with the third bin, and a fourth data model associated with the fourth bin. The method may further include using deep reinforcement learning, training a first brain based on the first data model, a second brain based on the second data model, a third brain based on the third data model, and a fourth brain based on the fourth data model. The method may further include using the first brain, the second brain, the third brain, and the fourth brain generating predicted supervisory control suggestions and collating the predicted supervisory control suggestions into a single data structure.

In another example, the present disclosure relates to systems for implementing various autonomous control methods, including the above method.

In yet another example, the present disclosure relates to a system, including at least one processor, where the system is configured to using a measurable attribute associated with a system, segment operational data associated with the system into at least a first bin and a second bin. The system may further be configured to train a first brain based on a first data model associated with the first bin and train a second brain based on a second data model associated with the second bin. The system may further be configured to using the first brain and the second brain, implemented by at least one processor, automatically generate predicted supervisory control suggestions for a plurality of supervisory setpoints associated with the system.

In another example, the present disclosure relates to a method including using a measurable attribute associated with a system, segmenting operational data associated with the system into at least a first bin and a second bin. The method may further include training a first brain based on a first data model associated with the first bin and training a second brain based on a second data model associated with the second bin. The method may further include using the first brain and the second brain, implemented by at least one processor, automatically generating predicted supervisory control suggestions for a plurality of supervisory setpoints associated with the system.

In yet another example, the present disclosure relates to a method including using a measurable attribute associated with a system, segmenting operational data associated with the system into at least a first bin and a second bin, where the segmenting the operational data associated with the system into the first bin and the second bin further comprises determining a transition boundary between the first bin and the second bin. The method may further include using deep reinforcement learning, training a first brain based on a first data model associated with the first bin and training a second brain based on a second data model associated with the second bin. The method may further include using the first brain and the second brain, implemented by at least one processor, automatically generating predicted supervisory control suggestions for a plurality of supervisory setpoints associated with the system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated byway of example and is not limited by the accompanying figures, in which like references indicate similar elements. Elements in the figures are illustrated for simplicity and clarity and have not necessarily been drawn to scale.

FIG. 1 is a block diagram of a heating, ventilation, and air conditioning (HVAC) system environment 100 in accordance with one example;

FIG. 2 shows a diagram of multiple levels of control for the HVAC system environment of FIG. 1 in accordance with one example;

FIG. 3 shows a diagram of a workflow for controlling the HVAC system environment of FIG. 1 in accordance with one example;

FIG. 4 shows a reinforcement learning graph associated with training one of the brains for a bin in accordance with one example;

FIG. 5 shows a graphical view of the bins associated with the HVAC system in accordance with one example;

FIG. 6 shows changes in the power usage by the HVAC system in accordance with one example;

FIG. 7 shows a diagram of a platform for configuring and controlling an artificial intelligence (AI) engine for implementing autonomous supervisory control in accordance with one example;

FIG. 8 shows a system environment for implementing autonomous control in accordance with one example;

FIG. 9 shows a computing system for implementing various parts of the platform for configuring and controlling an artificial intelligence (AI) engine for implementing autonomous supervisory control in accordance with one example;

FIG. 10 shows a flow chart of a method for implementing autonomous supervisory control in accordance with one example;

FIG. 11 shows a graph corresponding to an example method for identifying bin boundaries;

FIG. 12 shows three stages of a process for determining bin boundaries in accordance with one example;

FIG. 13 shows a graph corresponding to another example method for identifying bin boundaries; and

FIG. 14 shows a flow chart of a method for generating predicted supervisory control suggestions in accordance with one example.

### DETAILED DESCRIPTION

Examples described in this disclosure relate to autonomous control of supervisory setpoints using artificial intelligence. Certain examples relate to autonomously controlling supervisory setpoints using deep reinforcement learning and machine teaching as applied to, but not limited to, “HVAC-like” systems for smart building operations. The described examples are directed to supervisory control and thus are compute light. In addition, unlike some traditional artificial intelligence (AI) systems that take direct and intrusive control, the examples described herein are not disruptive to the existing operations and product lines of entities that may deploy the supervisory control systems and methods described herein. Finally, the present disclosure leverages a binning strategy, which allows the supervisory control to be effective even in a sparse and an uncertain data environment.

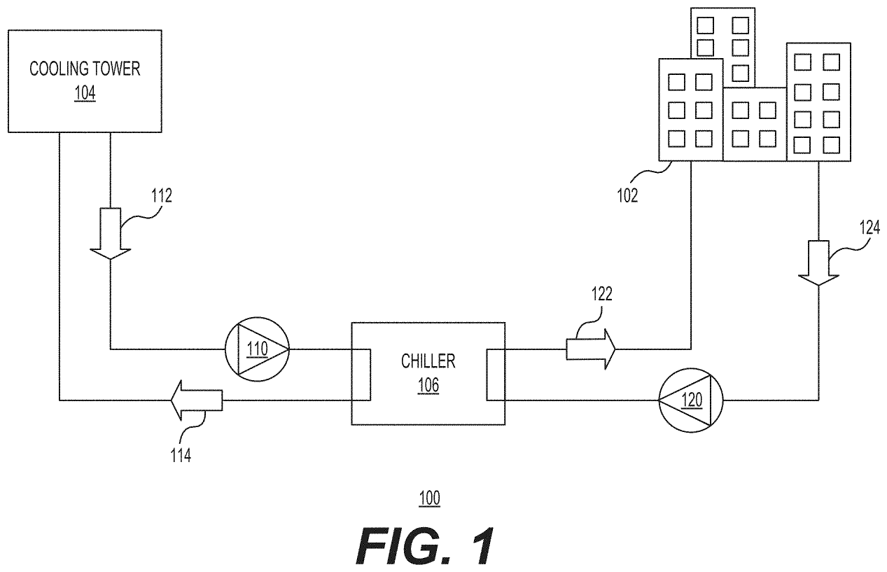

FIG. 1 is a block diagram of a heating, ventilation, and air conditioning (HVAC) system environment 100 in accordance with one example. HVAC system environment 100 may include a building 102 that is being cooled using an HVAC system, including a cooling tower 104 and a chiller 106. In this example, building 102 may be providing a certain load that chiller 106 is required to handle. In this example, cooling tower 104 may be coupled via at least one pump (e.g., pump 110) to chiller 106 and chiller 106 may be coupled to building 102 via at least one pump (e.g., pump 120). These pumps in combination with valves (not shown) and other components may control the flow of water (or another liquid). As an example, the water may flow between cooling tower 104 and chiller 106 in the directions represented by arrows 112 and 114. Water may flow between chiller and building 102 in the directions represented by arrows 122 and 124. In one example, the HVAC system may have differential pressure (dP) pumping control. This may be needed in HVAC systems with multiple chillers and pumps. Chillers may also be staged. In addition, there may be valves, such as flow control valves, to ensure balanced flow of water through multiple chillers in operation. The chilled water supply may be sent to the air handling units of building 102. The air handling units may use the chilled water to cool the air supplied to the spaces in building 102. Although FIG. 1 shows a certain number of components of an HVAC system environment 100 that are arranged in a certain manner, HVAC system environment 100 may include additional or fewer components. In addition, the HVAC system could be air cooled, mineral cooled, or use other techniques such as thermal storage with free cooling and evaporation. Moreover, HVAC system environment 100 and related control aspects are being used to illustrate the operation of autonomous control of supervisory setpoints using machine learning and machine teaching. As such, the methods disclosed in the present disclosure may be used with any system that in which a hierarchy of control may be established, and autonomous control is used to control the supervisory setpoints. As an example, instead of the HVAC system, a factory floor may be controlled. Other applications that may be controlled, include robotics, industrial automation, supply chain logistics, and structural engineering.

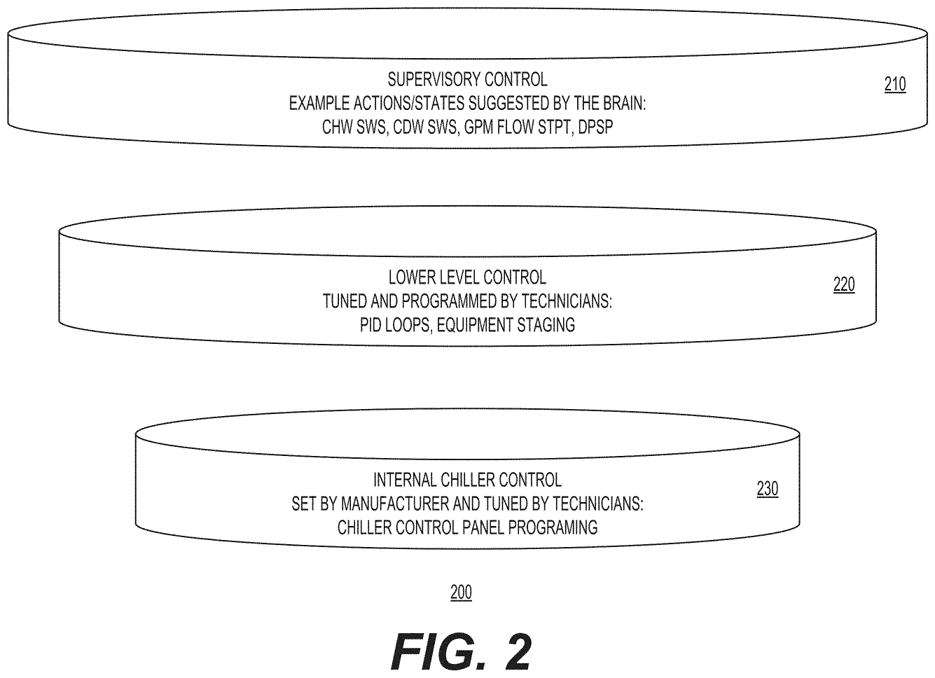

In one example, a trained “brain” using simulations and deep reinforcement learning (DRL) may be used to provide the control at the supervisory level. FIG. 2 shows a diagram of hierarchical control 200 for the HVAC system environment 100 of FIG. 1 in accordance with one example. In this example, hierarchical control 200 may include three levels of control: supervisory control 210, lower level control 220, and internal chiller control 230. In this example, supervisory control 210 may relate to four example control actions: (1) chilled water temperature setpoint (CHW SWS) relative to the outside air temperature, (2) condenser water temperature setpoint (CDW SWS) relative to the wet bulb temperature (a measure of the ambient relative humidity), (3) chilled water flow GPM STPT, (4) differential pressure (DPSP), and (5) chilled water setpoint relative to the return water temperature from the building. Lower level control 220 may include control aspects of the HVAC system that are tuned and programmed by technicians. Such control aspects may include proportional integral derivative (PID) loops and equipment staging. The proportional aspect may relate to a gain that depends on the difference between a setpoint and a measured process variable related to the setpoint. The integral aspect may relate to an integration or sum of the process variables. The derivative aspect may relate to the rate of change of certain variables. The PID loop may factor all three of these aspects to provide lower level control for the HVAC system. Equipment staging aspect may relate to deployment of additional or fewer chillers.

With continued reference to FIG. 2, inner chiller control 230 may correspond to control aspects set by the manufacturer of the chiller and tuned by technicians. As an example, inner chiller control may relate to the chiller control panel programming. Although FIG. 2 shows certain types of controls associated with hierarchical control 200 for an HVAC system, as such, the methods disclosed in the present disclosure may be used with any system in which a hierarchy of control may be established, and autonomous control is used to control the supervisory setpoints. In addition, the levels of hierarchy are not limited to just three; instead, there could be additional or fewer levels of hierarchy. Moreover, although FIG. 2 refers to certain example actions/states associated with the supervisory control level, other systems may include other actions/states.

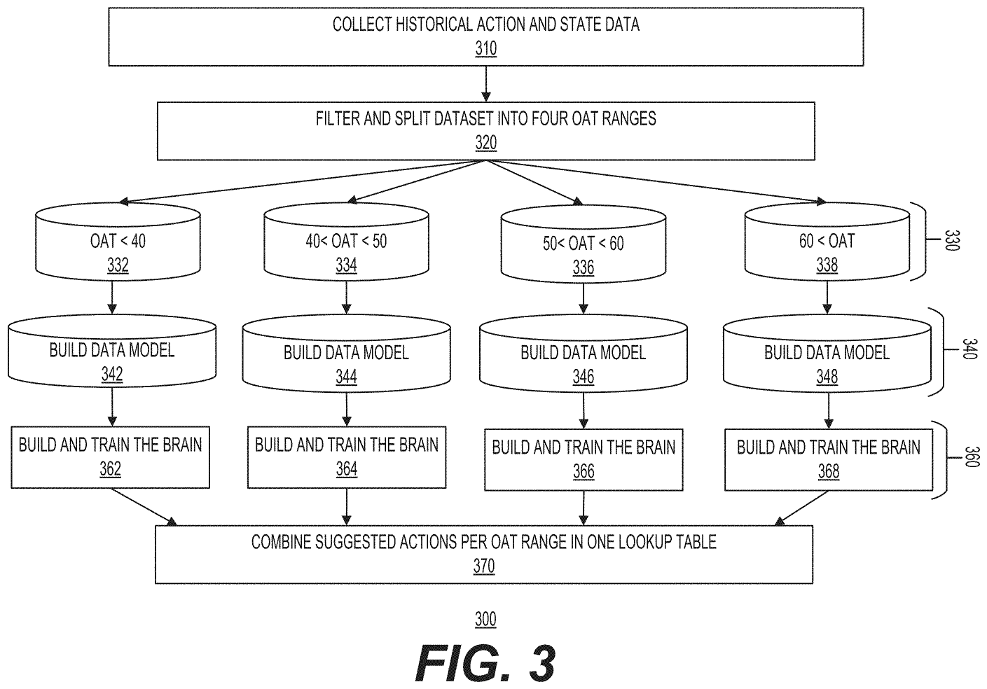

FIG. 3 shows a diagram of a workflow 300 for controlling the HVAC system environment 100 of FIG. 1 in accordance with one example. Workflow 300 may be used to build and deploy autonomous supervisory control for not only an HVAC system but also for any of the systems mentioned earlier. In general, any situation involving an environment controllable via a trained agent (e.g., a trained brain) may be controlled using workflow 300. Workflow 300 may include several stages. Stage 310 may relate to collecting historical action and state data. As an example, using the HVAC system example, the action data may relate to (1) chilled water temperature setpoint (CHW SWS), (2) condenser water temperature setpoint (CDW SWS), (3) chilled water flow GPM STPT, and (4) differential pressure (DPSP) and the state data may relate to power usage of the HVAC system and the cooling load.

Stage 320 may relate to filtering and splitting datasets into bins. The filtering step may include ignoring the temporal dependency in the historical state and action data related to the HVAC system. After the filtering step, in this example, the dataset may be segmented into separate bins 330 by the outside air temperature (OAT). Thus, in this example, the dataset may be segmented into four bins: bin 332 (for the data related to OAT<40 degrees Fahrenheit), bin 334 (for the data related to 40 degrees Fahrenheit<OAT<50 degrees Fahrenheit), bin 336 (for the data related to 50 degrees Fahrenheit<OAT<60 degrees Fahrenheit, and bin 338 (for the data related to 60 degrees Fahrenheit<OAT). Binning, however, is not limited to based on outside air temperature alone. Other attributes, including for example, the wet bulb temperature, which is a measure of the relative humidity, may also be used. Indeed, for other autonomous supervisory control situations other attributes, such as pressure, power, or other measurable attributes, may be used. In addition, the bin size need not be equal, as they can be unequal. Moreover, there is no restriction on the number of bins.

This type of structured binning may be accomplished by selecting the boundaries for the bins based on transition functions. Assuming there are no other constraints in terms of business requirements, operational realities, or legacy workflow, the bins may simply be based on transition boundaries. Thus, historical data may be evaluated to understand the evolution of the various states as a function of time; and the bin boundaries may be placed at, or close to, the transition boundaries. In one example, the transition boundaries may be determined qualitatively. As an example, if the evolution of the states makes a transition by a factor of 2 from one instance of time to another, then that may be viewed as an abrupt transition. The bin boundary may be selected based on this observed abrupt transition in one of the states. The abruptness of the transition may be a factor of 2 or even 20 and may depend on the control system and its context.

Stage 340 may relate to building data models for each bin. As an example, build data model 342 may relate to building a segmented data model corresponding to bin 332. Build data model 344 may relate to building a segmented data model corresponding to bin 334. Build data model 346 may relate to building a segmented data model corresponding to bin 336. Build data model 348 may relate to building a segmented data model corresponding to bin 338. As an example, as part of stage 340, the segmented dataset from each bin may be rearranged to prepare the dataset for a Markov decision process type of model. Any modeling approach may be used to model the Markov decision process, which then acts as a simulator for building and training the brain for each bin. As an example, the Markov decision process is used to rearrange the segmented dataset from each bin such that the future is only dependent on the present and is independent of the past. In these examples, the modeling of the historical data to come up with the model allows the autonomous control system to be trained without requiring large amounts of training data required by traditional machine learning algorithms. In one example, the Markov decision process can be characterized by a tuple (S, A, T, R), where: (1) S is a finite set of states; (2) A is a finite set of actions; (3) T is a state-transition function such that T(s′, a, s)=p(s′|, a); and (4) R is a local reward function. Thus, in the context of HVAC system environment 100 of FIG. 1, the Markov decision framework plays a critical role, because it requires from the environment model only an estimate of the transition function and no more. As used herein, the term “data model” includes, but is not limited to, any framework useable for organizing elements of data or control information relating to a control system. The organizing process may further include specifying relationships among the various elements of data or control information. Example data modeling techniques include, but are not limited to, the Markov decision process described earlier. In addition, the term “data model” does not exclude frameworks that lack a modeling technique such as the Markov decision process. As an example, any framework that can be used to train a machine learning algorithm without requiring large amounts of training data is covered by the term “data model.”

Stage 360 may relate to building and training the brain for each bin. As an example, build and train the brain 362 may correspond to the data model derived from build data model 342. Build and train the brain 364 may correspond to the data model derived from build data model 344. Build and train the brain 366 may correspond to the data model derived from build data model 346. Build and train the brain 368 may correspond to the data model derived from build data model 348. Each of these brains may be built and trained using machine teaching. As used herein the term “brain” includes, but is not limited, to one or more neural networks, one or more neural network layers, or any other trainable artificial intelligence. The trained brains may be deployed using a client/server architecture or any other architecture that allows the trained “brain” to respond to control and/or data in relation to a control system (e.g., the HVAC system).

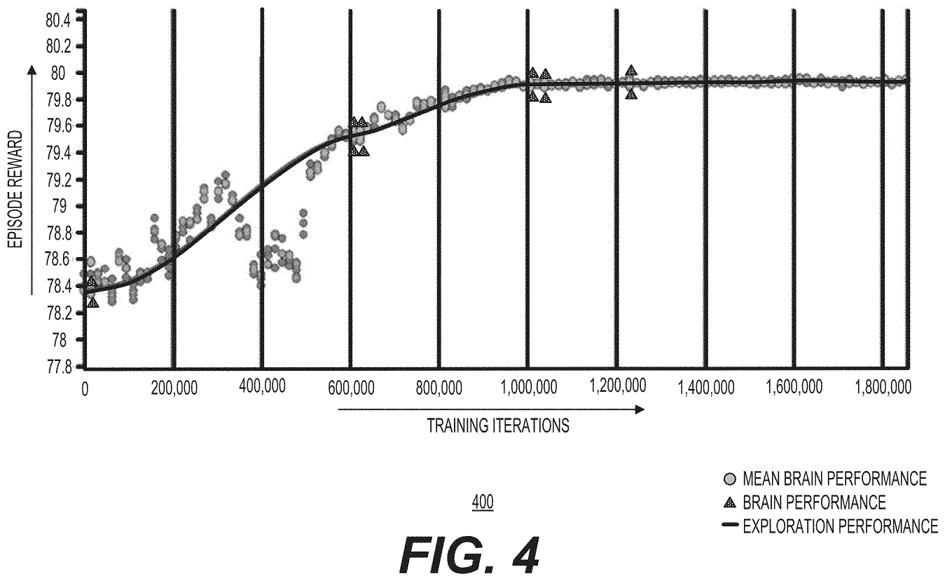

FIG. 4 shows a reinforcement learning graph 400 associated with training one of the brains for a bin in accordance with one example. Graph 400 corresponds to training of the brain for bin 1 (Outside Air Temperature (OAT)<40 degrees Fahrenheit) shown in FIG. 3. Graph 400 shows the improvement in the brain performance, the mean brain performance, and the exploration performance with an increasing number of training iterations. Graph 400 tracks the episode reward per episode as the training progresses. Although graph 400 relates to the training of a brain using the Bonsai platform provided by Microsoft®, other types of systems may also be used to train the brains associated with the bins.

Any autonomous control system similar to the HVAC system that has a defined start state, iterates over time, and responds to external inputs may be implemented using the workflow 300. A specific start state, such as a certain temperature setpoint, may be required to allow the brain to learn from a wide array of conditions. The machine teaching using deep reinforcement learning may result in the brain being able to take a set of discrete actions to affect the state even in an uncharted territory. In sum, each of the brains for a respective bin should be able to predict in contexts and scenarios that it has not explicitly encountered in the dataset corresponding to the respective bin. The brain may learn using any of the learning algorithms, including Distributed Deep Q Network, Proximal Policy Optimization, or Soft Actor Critic. Once the brains for each bin have been trained, the next stage is prediction. In case of the HVAC system, the states are the power usage of the HVAC system and the cooling load and thus the goal of learning by the brain is to maximize energy efficiency while meeting the building's cooling demand.

Thus, in stage 370, the suggested actions for each bin may be combined in one lookup table or a similar data structure. The suggested actions may be based on predictions for each brain associated with a respective bin. Table 1 below shows an example of the lookup table.

TABLE 1

| | Brain Recommendations | | | | | | |
|---|---|---|---|---|---|---|---|
| | | | | | | Differential | Projected |
| | Chiller | | Condenser | | GPM Flow | Pressure | Efficiency |
| Bins | STPT | | STPT | | STPT | STPT | Gain |
| OAT < 40° F. | 43° | F. | 67-69° | F. | 2164 GPM | 18 PSI | ~+12-15% |
| 40° F. < OAT < 50° F. | 46° | F. | 66° | F. | 2250 GPM | 15 PSI | ~7-8% |
| 50° F. < OAT < 60° F. | 47-48° | F. | 75° | F. | 2250 GPM | 15 PSI | ~15% |
| OAT > 60° F. | 49° | F. | 76° | F. | 2250 GPM | 15 PSI | ~10% |

In one example, the lookup table may be integrated with a dashboard associated with the HVAC system. In this manner, the lookup table may allow for the autonomous supervisory control of the HVAC system. The integration with using software may be such that an operator of the HVAC system may override some of the recommendations of the brains associated with the respective bins. The lookup table may be integrated via other means, including by using a hardware controller (e.g., a field programmable gate array (FPGA) or a programmable logic controller (PLC)).

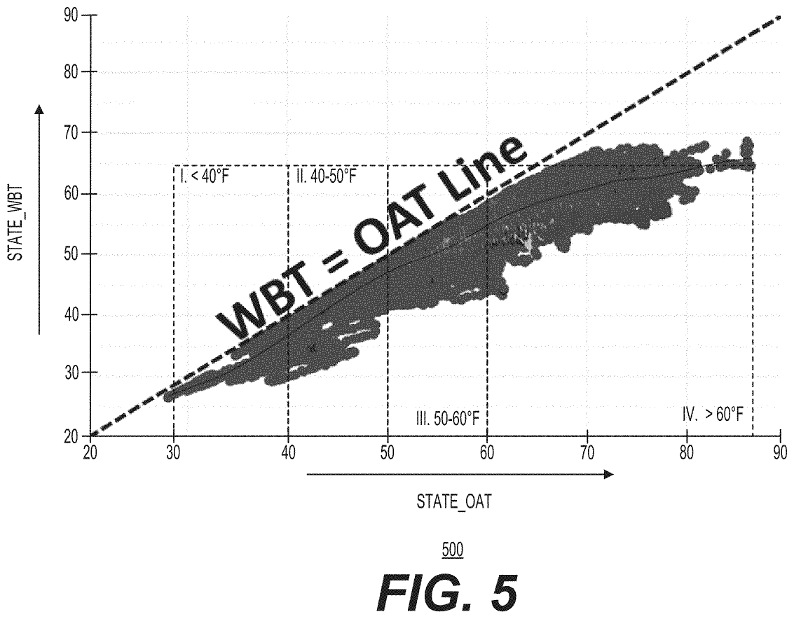

FIG. 5 shows a graphical view 500 of the bins associated with the HVAC system in accordance with one example. The horizontal axis corresponds to outside air temperature (OAT) separated by 10° F. intervals and the vertical axis corresponds to the wet bulb temperature (WBT), which is a proxy for the humidity. In this example, when the WBT is equal to the OAT, then that indicates high humidity. In addition, as further explained later in more detail, STATE_WBT and STATE_OAT are exogenous variables and are not states or actions in the context of the deep reinforcement learning.

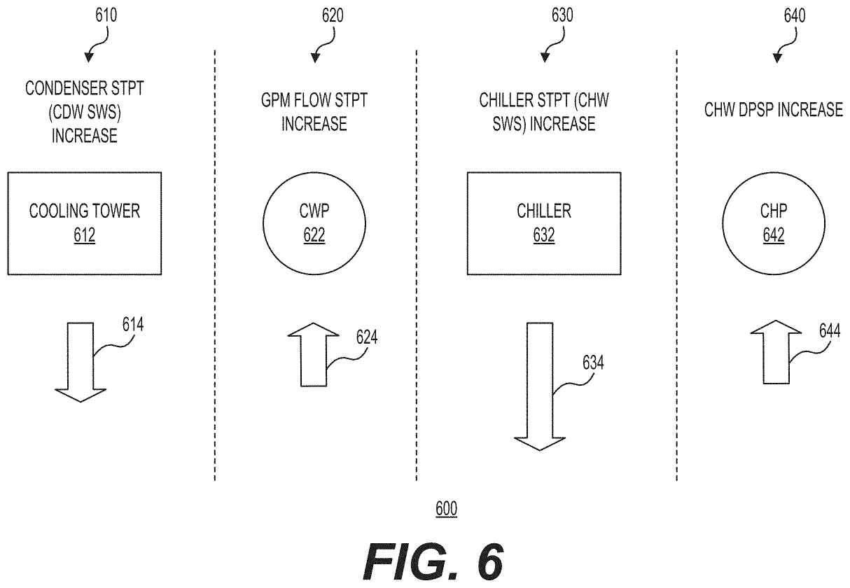

FIG. 6 shows changes 600 in the power usage by the HVAC system in accordance with one example. As explained earlier, the various components of the HVAC system may consume power based on the cooling load being serviced by the HVAC system. The power usage may be based on the recommended setpoints by the autonomous supervisory control system. Portion 610 corresponds to any increases or decreases in the power usage by the cooling tower (e.g., cooling tower 612). In this example, arrow 614 shows that the power usage by the cooling tower is decreased when the condenser water temperature setpoint (CDW SWS) is increased. Portion 620 corresponds to the power usage by the cooling pump (e.g., CWP 622). In this example, arrow 624 shows that the power usage by the cooling pump is increased when the chilled water flow GPM STPT is increased. Portion 630 corresponds to the power usage by the chiller (e.g., chiller 632). In this example, arrow 634 shows that the power usage by the chiller (e.g., chiller 632) is decreased as a result in the increase of the chiller water temperature setpoint (CHW SWS). Portion 640 corresponds to the power usage by the chilled water pressure differential. In this example, arrow 644 shows that the power usage by the chilled water pump (e.g., CHP 642) is increased when the differential pressure (DPSP) is increased. These changes in the power usage by the various components of the HVAC system, however, result in a decrease in the net power usage of the HVAC system while still meeting the cooling load requirements. Thus, the predicted setpoints by the autonomous supervisory control system result in efficiency gains. In accordance with one example, table 2 below shows the efficiency gains as a result of implementing the autonomous supervisory control described earlier.

TABLE 2

| | | | | |
|---|---|---|---|---|
| | | | % Efficiency | % Efficiency |
| | | | Gain | Gain |
| BIN | Before | After | (Actual) | (Brain) |

| | | | | | |
|---|---|---|---|---|---|
| 55-65° | F. | 0.46 | 0.43 | 7% | ~8-10% |
| 65-75° | F. | 0.43 | 0.41 | 5% | ~3-4% |
| 75-85° | F. | 0.46 | 0.45 | 2% | ~2-3% |

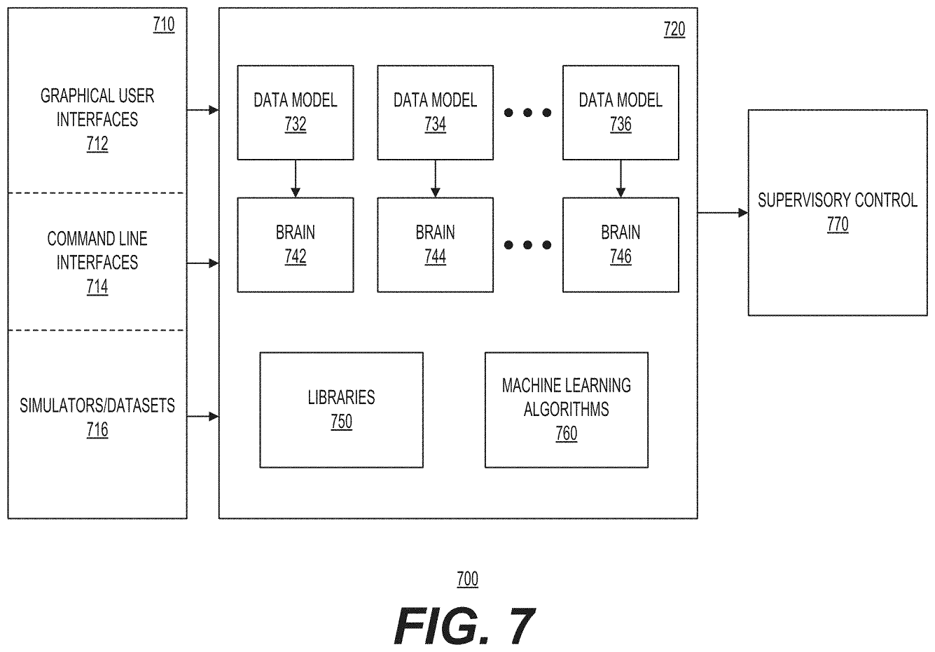

FIG. 7 shows a diagram of a platform 700 for configuring and controlling an artificial intelligence (AI) engine 720 for implementing autonomous supervisory control in accordance with one example. Platform 700 may include AI engine 720 coupled to a set of interfaces and data/simulation sources. In this example, AI engine 720 may be coupled to graphical user interfaces 712 and command line interfaces 714. Graphical user interfaces 712 may allow visualization of graphs and other visual aids used in training the brains associated with the bins. Command line interfaces 714 may also be used. Such interfaces may also be configured to receive commands via an application programming interface (API). Simulators/datasets 716 may be the training sources on which AI engine 720 may be trained. Simulators may include instructions corresponding to models for simulating transitions from states to states as actions are applied. As explained earlier, Markov decision process based simulators may be used to simulate supervisory control for various types of systems, including the HVAC systems. Data models for each of the bins (e.g., data model 732 for one of the bins, data model 734 for another bin, and data model 736 for another bin) may be used to train the brains (e.g., brain 742, brain 744, and brain 746) for the respective bins.

With continued reference to FIG. 6, AI engine 720 may further include libraries 750 and machine learning algorithms 760. AI engine 720 may include instructions allowing it to select appropriate libraries and learning algorithms based on heuristics or other approaches. As an example, machine learning algorithms 760 may include any of the learning and inference techniques such as Linear Regression, Support Vector Machine (SVM) set up for regression, Random Forest set up for regression, Gradient-boosting trees set up for regression and neural networks. Linear regression may include modeling the past relationship between independent variables and dependent output variables. Neural networks may include artificial neurons used to create an input layer, one or more hidden layers, and an output layer. Each layer may be encoded as matrices or vectors of weights expressed in the form of coefficients or constants that might have been obtained via off-line training of the neural network. Neural networks may be implemented as Recurrent Neural Networks (RNNs), Long Short Term Memory (LSTM) neural networks, or Gated Recurrent Unit (GRUs). All of the information required by a supervised learning-based model may be translated into vector representations corresponding to any of these techniques.

An example LSTM network may comprise a sequence of repeating RNN layers or other types of layers. Each layer of the LSTM network may consume an input at a given time step, e.g., a layer's state from a previous time step, and may produce a new set of outputs or states. In the case of using the LSTM, a single chunk of content may be encoded into a single vector or multiple vectors. As an example, a word or a combination of words (e.g., a phrase, a sentence, or a paragraph) may be encoded as a single vector. Each chunk may be encoded into an individual layer (e.g., a particular time step) of an LSTM network. An example LSTM layer may be described using a set of equations, such as the ones below:

fₜ=σ(W_{f}·[hₜ₋₁xₜ]+b_{c})

iₜ=σ(W_{f}·[hₜ₋₁xₜ]+bᵢ)

\tilde{c}ₜ=tanh(W_{c}·[hₜ₋₁xₜ]+b_{c})

cₜ=fₜ∘cₜ₋₁+iₜ∘\tilde{c}ₜ

oₜ=σ(Wₒ·[hₜ₋₁xₜ]+bₒ)

hₜ=oₜ∘tanh(cₜ)

In this example, in the above equations σ is the element wise sigmoid function and ∘ represents Hadamard product (element-wise). In this example, fₜ, iₜ, and oₜ are forget, input, and output gate vectors respectively, and cₜ is the cell state vector. In this example, inside each LSTM layer, the inputs and hidden states may be processed using a combination of vector operations (e.g., dot-product, inner product, or vector addition) or non-linear operations, if needed.

Still referring to FIG. 7, AI engine 720 may be trained using deep reinforcement learning against the simulated models. The training may involve teaching each of the brains for the various bins to reach specific outcomes based on simulations. A simulator connected to the bin brains may run a simulation, which the AI engine 720 may train on. Using the simulation, which imitates a real-world situation in a virtual environment, may enable a user to rapidly test and predict scenarios associated with control of a system such as an HVAC system. An iteration of the training may be represented by one state→action→new-state transition in the environment. The training loop for each bin may start when the simulator sends AI engine 720 a state; next, the AI engine 720 may reply with an action; then, the simulator may use this action to advance the environment (deployed or simulated) and compute a new state as well as a reward. An episode may be a series of iterations, starting in some initial state and ending when the environment hits a termination condition and the environment resets for the next episode. The reward(s) may be the objective of the training. During training, AI engine 720 may learn to maximize a reward given by the simulation's reward function over the course of an episode. Although FIG. 7 shows platform 700 as including a certain number of components that are arranged in a certain manner, platform 700 may include additional or fewer components arranged differently. The instructions corresponding to machine learning algorithms could be encoded as hardware corresponding to an A/I processor. As an example, the A/I processor may be implemented using an FPGA with the requisite functionality.

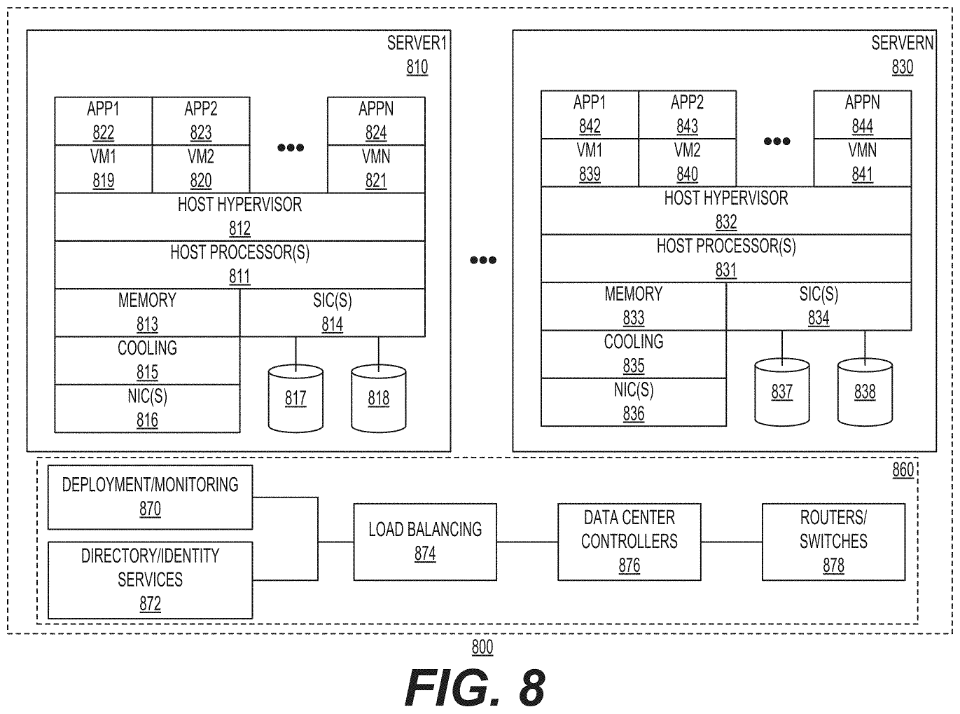

FIG. 8 shows a system environment 800, which may correspond to a portion of a data center, and which may be used to implement at least some functionality associated with the autonomous supervisory control systems. As an example, the data center may include several clusters of racks including platform hardware, such as server nodes, storage nodes, networking nodes, or other types of nodes. Server nodes may be connected to switches to form a network. The network may enable connections between each possible combination of switches. As used in this disclosure, the term data center may include, but is not limited to, some or all of the data centers owned by a cloud service provider, some or all of the data centers owned and operated by a cloud service provider, some or all of the data centers owned by a cloud service provider that are operated by a customer of the service provider, any other combination of the data centers, a single data center, or even some clusters in a particular data center. System environment 800 may include server1 810 and serverN 830. System environment 800 may further include data center related functionality 860, including deployment/monitoring 870, directory/identity services 872, load balancing 874, data center controllers 876 (e.g., software defined networking (SDN) controllers and other controllers), and routers/switches 878. Server1 810 may include host processor(s) 811, host hypervisor 812, memory 813, storage interface controller(s) (SIC(s)) 814, cooling 815, network interface controller(s) (NIC(s)) 816, and storage disks 817 and 818. ServerN 830 may include host processor(s) 831, host hypervisor 832, memory 833, storage interface controller(s) (SIC(s)) 834, cooling 835, network interface controller(s) (NIC(s)) 836, and storage disks 837 and 838.

With continued reference to FIG. 8, server1 810 may be configured to support virtual machines, including VM1 819, VM2 820, and VMN 821. The virtual machines may further be configured to support applications, such as APP1 822, APP2 823, and APPN 824. ServerN 830 may be configured to support virtual machines, including VM1 839, VM2 840, and VMN 841. The virtual machines may further be configured to support applications, such as APP1 842, APP2 843, and APPN 844. Each of server1 810 and serverN 830 may also support various types of services, including file storage, application storage, and block storage for the various tenants of the cloud service provider responsible for managing system environment. In this example, system environment 800 may be enabled for multiple tenants using the Virtual eXtensible Local Area Network (VXLAN) framework. Each virtual machine (VM) may be allowed to communicate with VMs in the same VXLAN segment. Each VXLAN segment may be identified by a VXLAN Network Identifier (VNI).

Deployment/monitoring 870 may interface with a sensor API that may allow sensors to receive and provide information via the sensor API. Software configured to detect or listen to certain conditions or events may communicate via the sensor API any conditions associated with devices that are being monitored by deployment/monitoring 870. Remote sensors or other telemetry devices may be incorporated within the data centers to sense conditions associated with the components installed therein. Remote sensors or other telemetry may also be used to monitor other adverse signals in the data center and feed the information to deployment/monitoring 870. As an example, if fans that are cooling a rack stop working then that may be sensed by the sensors and reported to the deployment/monitoring 870. Although FIG. 8 shows system environment 800 as including a certain number of components arranged and coupled in a certain way, it may include fewer or additional components arranged and coupled differently. In addition, the functionality associated with system environment 800 may be distributed or combined, as needed.

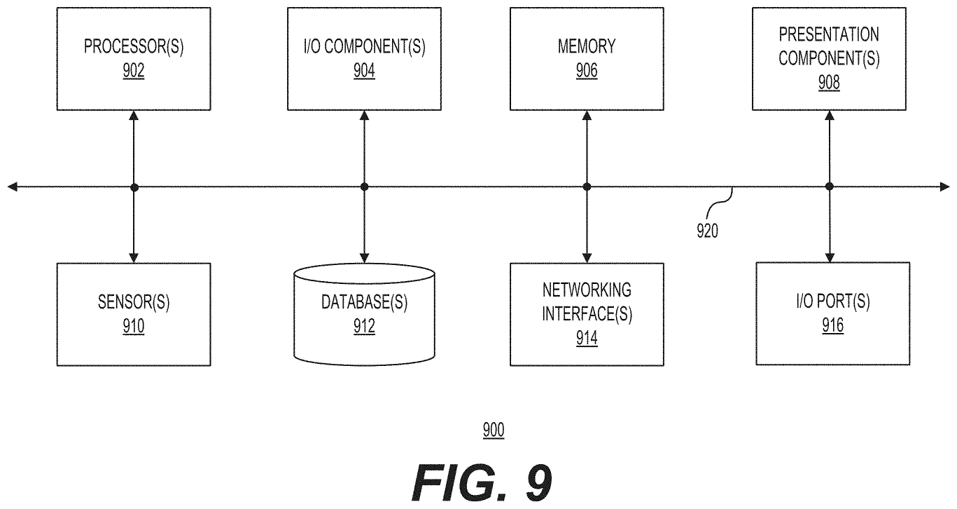

FIG. 9 is a block diagram of a computing system 900 for performing methods associated with the present disclosure in accordance with one example. As an example, computing system 900 may be used to implement the various parts of platform 700 of FIG. 7. Computing system 900 may include a processor(s) 902, I/O component(s) 904, memory 906, presentation component(s) 908, sensors 910, database(s) 912, networking interfaces 914, and I/O port(s) 916, which may be interconnected via bus 920. Processor(s) 902 may execute instructions stored in memory 906. Processor(s) 902 may include CPUs, GPUs, ASICs, FPGAs, or other types of logic configured to execute instructions. I/O component(s) 904 may include components such as a keyboard, a mouse, a voice recognition processor, or touch screens. Memory 906 may be any combination of non-volatile storage or volatile storage (e.g., flash memory, DRAM, SRAM, or other types of memories). Presentation component(s) 908 may include displays, holographic devices, or other presentation devices. Displays may be any type of display, such as LCD, LED, or other types of display. Sensor(s) 910 may include telemetry or other types of sensors configured to detect, and/or receive, information (e.g., conditions associated with the various devices in a data center). Sensor(s) 910 may include sensors configured to sense conditions associated with CPUs, memory or other storage components, FPGAs, motherboards, baseboard management controllers, or the like. Sensor(s) 910 may also include sensors configured to sense conditions associated with racks, chassis, fans, power supply units (PSUs), or the like. Sensor(s) 910 may also include sensors configured to sense conditions associated with Network Interface Controllers (NICs), Top-of-Rack (TOR) switches, Middle-of-Rack (MOR) switches, routers, power distribution units (PDUs), rack level uninterrupted power supply (UPS) systems, or the like.

Still referring to FIG. 9, database(s) 912 may be used to store any of the data or files (e.g., data models, historical data, or other datasets) as needed for the performance of methods described herein. Database(s) 912 may be implemented as a collection of distributed databases or as a single database. Network interface(s) 914 may include communication interfaces, such as Ethernet, cellular radio, Bluetooth radio, UWB radio, or other types of wireless or wired communication interfaces. I/O port(s) 916 may include Ethernet ports, Fiber-optic ports, wireless ports, or other communication ports.

Instructions corresponding to various parts of platform 700 may be stored in memory 906 or another memory. These instructions when executed by processor(s) 902, or other processors, may provide the functionality associated with platform 700. The instructions corresponding to platform 700, and related components, could be encoded as hardware corresponding to an A/I processor. In this case, some or all of the functionality associated with the learning-based analyzer may be hard-coded or otherwise provided as part of an A/I processor. As an example, A/I processor may be implemented using a field programmable gate array (FPGA) with the requisite functionality. Other types of hardware such as ASICs and GPUs may also be used. The functionality associated with platform 600 may be implemented using any appropriate combination of hardware, software, or firmware. Although FIG. 9 shows computing system 900 as including a certain number of components arranged and coupled in a certain way, it may include fewer or additional components arranged and coupled differently. In addition, the functionality associated with computing system 800 may be distributed or combined, as needed.

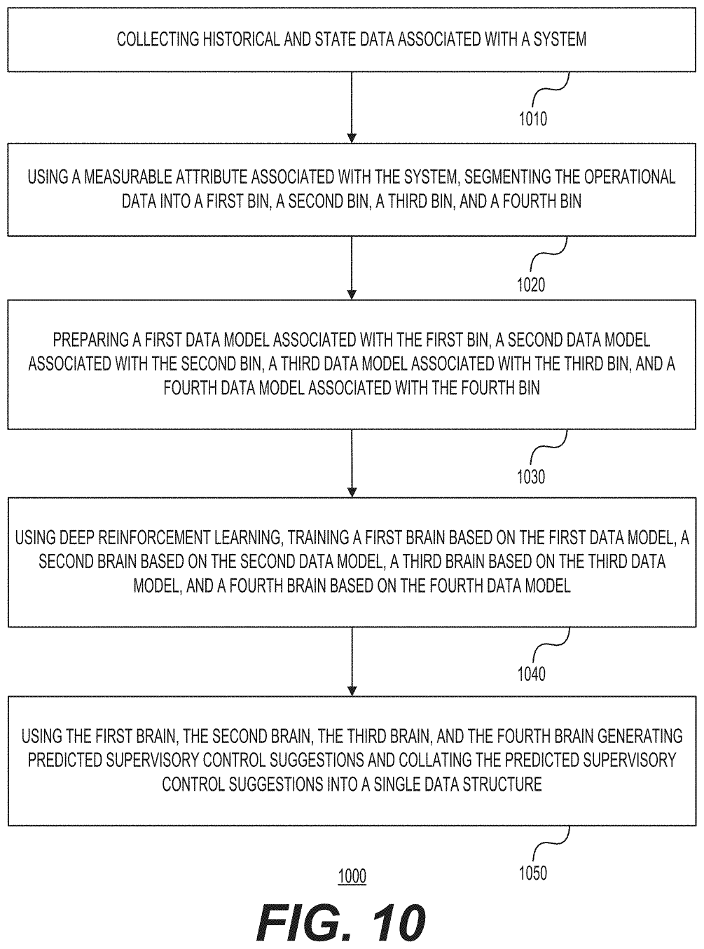

FIG. 10 shows a flow chart 1000 of a method, implemented by at least one processor, for implementing autonomous supervisory control in accordance with one example. Step 1010 may include collecting historical and state data associated with a system (e.g., the HVAC system described earlier). As explained earlier, with respect to FIGS. 1-9, various techniques and components may be used for performing this step. Moreover, the system may be an HVAC system or any other system that requires supervisory control and in which the control may be split into a hierarchical fashion. In addition, the historical and state data may be filtered to create the operational data associated with the system.

Step 1020 may include using a measurable attribute associated with the system, segmenting the operational data into a first bin, a second bin, a third bin, and a fourth bin. As explained earlier, with respect to FIGS. 1-9, various techniques and components may be used for performing this step. In addition, the number of bins may be more or less than four. In the HVAC system, as an example, the measurable attribute may be the outside air temperature or the wet bulb temperature.

Step 1030 may include preparing a first data model associated with the first bin, a second data model associated with the second bin, a third data model associated with the third bin, and a fourth data model associated with the fourth bin. As explained earlier, with respect to FIGS. 1-9, various techniques and components may be used for performing this step. As an example, as described earlier, the data models may be based on a Markov decision process.

Step 1040 may include using deep reinforcement learning, training a first brain based on the first data model, a second brain based on the second data model, a third brain based on the third data model, and a fourth brain based on the fourth data model. As explained earlier, with respect to FIGS. 1-9, various techniques and components may be for performing this step. As an example, as described earlier, deep neural networks (DNNs) may be used to training each of the respective brains.

Step 1050 may include using at least the first brain, the second brain, the third brain, and the fourth brain, generating predicted supervisory control suggestions and then collating the predicted supervisory control suggestions into a single data structure. As explained earlier, with respect to FIGS. 1-9, various techniques and components may be used for performing this step. As an example, as explained earlier, the predicted autonomous control suggestions may be collated into a lookup table.

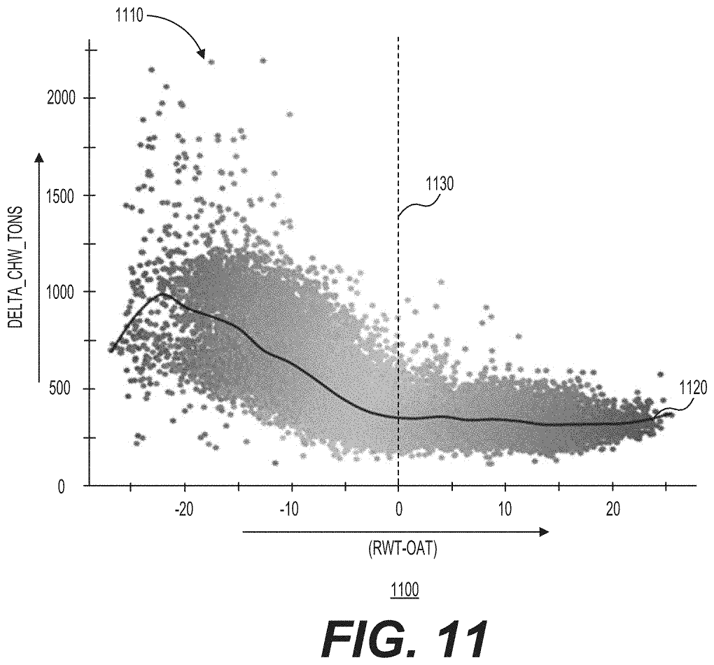

FIG. 11 shows a graph 1100 corresponding to an example method for identifying bin boundaries. As part of this method, using the HVAC system as an example, the bin boundaries based on the outside air temperature (OAT) may be determined by identifying rapid transition points in a plot of a state for the HVAC system. Graph 1100 shows the values of the difference (e.g., delta) between the return water temperature and the outside air temperature (OAT) along the X-axis. In one example, the return water temperature may correspond to the flow between chiller 106 of FIG. 1 and building 102 of FIG. 1 in the direction represented by arrow 124. Graph 1100 shows the difference (or delta) in the amount of the chilled water tonnage (DELTA_CHW_TONS) along the Y-axis. Graph 1100 shows the outside air temperature values plotted as dots 1110. Plot 1120 shows a rapid transition (indicated by dotted line 1130 in FIG. 11) in the amount of DELTA_CHW_TONS at a point where the outside air temperature (OAT) value is approximately 55 degrees Fahrenheit. In one example, once one or more rapid transition points have been detected, a consistency check may be performed. As an example, the relevant data and control information may be reviewed to determine whether a rapid transition in the amount of DELTA_CHW_TONS is expected at this particular OAT. Although FIG. 11 shows a certain way of determining bin boundaries based on rapid transition points, other methods may also be used. As an example, bin boundaries may be determined by monitoring the HVAC system for certain events, such as when an extra chiller is turned on, or for air-cooled systems when an extra cooling fan is turned on.

In another example, using the HVAC system as an example, the bin boundaries based on the outside air temperature (OAT) may be identified by detecting changes in the dynamics of the HVAC system in relation to predicted values of a state associated with the HVAC system. In this example, the tonnage of the chilled water, which is viewed as a demand state used by the HVAC system, is the state that is predicted by the underlying deep neural network (DNN) model. In one example, the changes in the dynamics of the HVAC system may be identified by determining a difference in the predicted values of the demand state in the forward direction (D+) and in the backward direction (D−). To accomplish this, a forward data model may be created that captures the dynamic behavior of the HVAC system forward in time (e.g., time=0 to time=t+1). In one example, the forward data model may relate to the organization of the neural network training data such that the neural network processing includes receiving: (1) values for one or more current states of the system, and (2) the current inputs, and providing values for one or more of the next states. In terms of an equation, the forward data model may be expressed as: S(t+1)=NNModel(S(t), a(t)), where S(t+1) corresponds to the next state(s), S(t) corresponds to the current state(s), and a(t) corresponds to the action(s).

TABLE 3

| | | | Exogenous | |
|---|---|---|---|---|
| | State | | Variable(s) | |
| | (e.g., | | (e.g., | |
| | Chilled | | Outside Air | |
| | Water | Other | Temperature | |
| Time | Tonnage) | State(s) | (OAT)) | Action(s) |
| 0 | TON(0) | OS(0) | OAT(0) | a(0) |
| 1 | TON(1) | OS(1) | OAT(1) | a(1) |
| 2 | TON(2) | OS(2) | OAT(2) | a(2) |
| . . . | . . . | . . . | . . . | . . . |
| t | TON(t) | OS(t) | OAT(t) | a(t) |
| t + 1 | TON(t + 1) | OS(t + 1) | OAT(t + 1) | a(t + 1) |

Table 3 above shows an example of a forward data model. In this example, the states include chilled water tonnage and other state(s). The action(s) may correspond to any one or more of: (1) chilled water temperature setpoint (CHW SWS) relative to the outside air temperature, (2) condenser water temperature setpoint (CDW SWS) relative to the wet bulb temperature (a measure of the ambient relative humidity), (3) chilled water flow GPM STPT, (4) differential pressure (DPSP), and (5) chilled water setpoint relative to the return water temperature from the building. With continued reference to Table 3 above, in one example, at time t, values of TON(t), OS(t) and a(t) are processed as inputs and the predicted values for TON(t+1) and OS(t+1) are generated.

A backward data model may be created that captures the inverse dynamic behavior of the HVAC system backward in time (e.g., time=t+1 to time=0). In one example, the backward data model may relate to the organization of the neural network training data such that the neural network processing includes receiving: (1) values for one or more current states of the system, and (2) the current inputs, and providing values for one or more of the previous states. In terms of an equation, the backward data model may be expressed as: S(t−1)=NNModel(S(t), a(t−1)), where S(t−1) corresponds to the previous state(s), S(t) corresponds to the current state(s), and a(t−1) corresponds to the action(s).

TABLE 4

| | State | | Exogenous | |
|---|---|---|---|---|
| | (e.g., | | Variable(s) | |
| | Chilled | | (Outside Air | |
| | Water | Other | Temperature | |
| Time | Tonnage) | State(s) | (OAT)) | Action(s) |
| t + 1 | TON(t + 1) | OS(t + 1) | OAT(t + 1) | a(t) |
| t | TON(t) | OS(t) | OAT(t) | a(t − 1) |
| . . . | . . . | . . . | . . . | . . . |
| 1 | TON(1) | OS(1) | OAT(1) | a(0) |
| 0 | TON(0) | OS(0) | OAT(0) | |

Table 4 above shows an example of a backward data model. In this example, the states include chilled water tonnage and other state(s). The action(s) may correspond to any one or more of (1) chilled water temperature setpoint (CHW SWS) relative to the outside air temperature, (2) condenser water temperature setpoint (CDW SWS) relative to the wet bulb temperature (a measure of the ambient relative humidity), (3) chilled water flow GPM STPT, (4) differential pressure (DPSP), and (5) chilled water setpoint relative to the return water temperature from the building. With continued reference to Table 4 above, in one example, at time t+1, values of TON(t+1), OS(t+1) and a(t) are processed as inputs and the predicted values for TON(t) and OS(t) are generated.

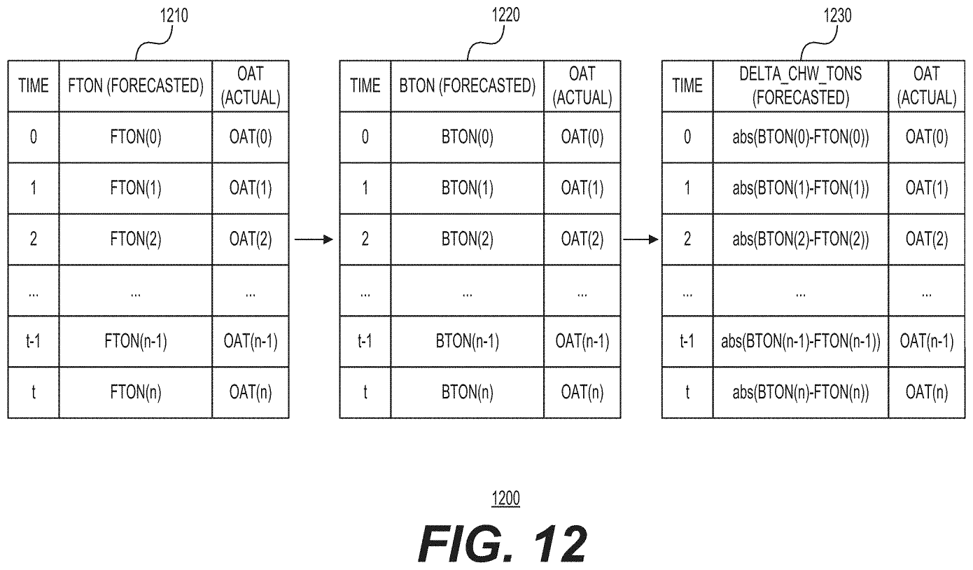

FIG. 12 shows three stages of a process 1200 for determining bin boundaries in accordance with one example. This example relates to the HVAC system described earlier. Having created both the forward data model and the backward data model described earlier, predictions may be made using the same historical data and an absolute difference between the predictions may be calculated. In stage 1210, the forward predicted tonnage of the chilled water may be calculated using the equation: FTON(t)=ForwardModel (S(t−1), a(t−1). In stage 1220, the backward predicted tonnage of the chilled water may be calculated using the equation: BTON(t)=BackwardModel (S(t+1), a(t). In stage 1230, the absolute difference between the forward predicted values and the backward predicted values may be determined using the equation: abs(BTON(t)−FTON(t)).

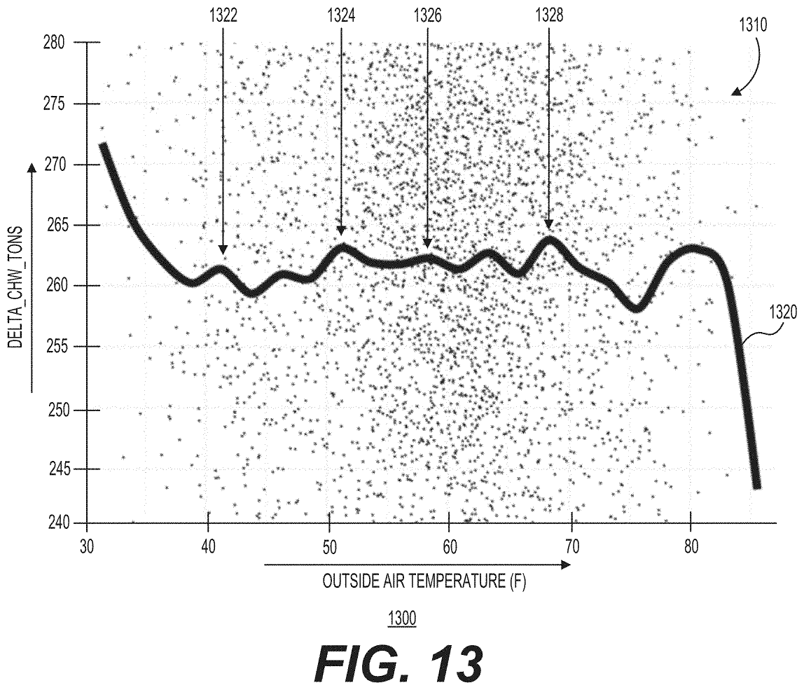

FIG. 13 shows a graph 1300 corresponding to another example method for identifying bin boundaries. Graph 1300 shows the values of the outside air temperature (OAT) from 30 degrees Fahrenheit to little over 80 degrees Fahrenheit along the X-axis. Graph 1300 shows the difference (or delta) in the amount of the predicted chilled water tonnage (DELTA_CHW_TONS) along the Y-axis. Graph 1300 shows the outside air temperature values plotted as dots 1310. Plot 1320 shows the absolute difference (or delta) between the predicted values of the chilled water tonnage (an example demand state) in the forward direction (D+) and in the backward direction (D−). Plot 1320 includes peaks 1322, 1324, 1326, and 1328 in the difference between the predicted values of the chilled water tonnage (an example demand state) in the forward direction (D+) and in the backward direction (D−). Each peak may represent the absolute error that is representative of the non-linear and difficult to capture changes in the dynamics of the HVAC system with respect to the outside air temperature (OAT). In this example, the top three peaks (1322, 1324, and 1328) in plot 1320 may correspond to bin boundaries. Accordingly, the data may be segmented based on the index (e.g., OAT) chosen for segmentation. Apart from the above two different techniques for identifying bin boundaries, other techniques may also be used. As an example, bin boundaries may be selected based on other inputs, including expert opinion and the knowledge relating to the HVAC system.

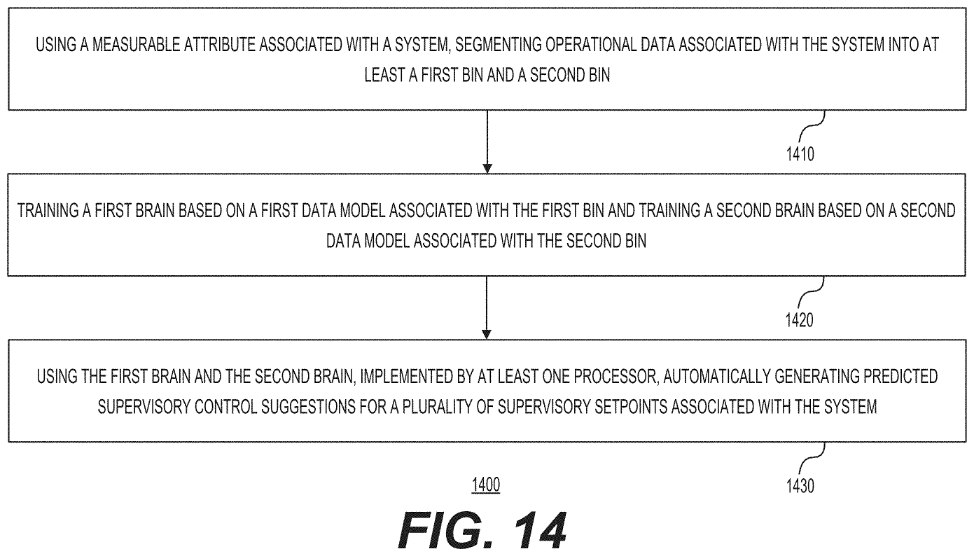

FIG. 14 shows a flow chart 1400 of a method for generating predicted supervisory control suggestions in accordance with one example. The method may include steps 1410, 1420, and 1430. Step 1410 may include using a measurable attribute associated with a system, segmenting operational data associated with the system into at least a first bin and a second bin. In one example, segmenting the operational data associated with the system into the first bin and the second bin further may include determining a transition boundary between the first bin and the second bin. As explained earlier, the transition boundary may relate to a transition in predicted values of at least one state associated with the system. Moreover, as explained earlier with respect to FIGS. 12 and 13, the transition in the predicted values of the at least one state is determined by a first set of training data corresponding to a forward data model and a second set of training data corresponding to a backward data model, where the forward data model relates to a dynamic behavior of the system forward in time and the backward data model relates to a dynamic behavior of the system backward in time. As explained earlier with respect to FIGS. 12 and 13, the transition in the predicted values of the at least one state is determined by determining differences between a first set of predicted values of the at least one state based on the forward data model and a second set of predicted values of the at least one state based on the backward data model. As explained earlier, with respect to FIGS. 1-9, various techniques and components may be used for performing this step. Processor(s) 902 may execute instructions corresponding to the various components required to perform this step. In the HVAC system, as an example, the measurable attribute may be the outside air temperature or the wet bulb temperature.

Step 1420 may include training a first brain based on a first data model associated with the first bin and training a second brain based on a second data model associated with the second bin. As explained earlier, each of the first brain and the second brain is trained using a Markov decision process model characterized by a tuple comprising: (1) a finite set of states associated with the system, (2) a finite set of actions associated with the system, (3) a state transition function associated with the system, and (4) a reward function associated with the system. In one example, neither the finite set of states associated with the system nor the finite set of actions associated with the system may include the measurable attribute associated with the system. As explained earlier, with respect to FIGS. 1-9, various techniques and components may be used for performing this step. Processor(s) 902 may execute instructions corresponding to the various components required to perform this step.

Step 1430 may include using the first brain and the second brain, implemented by at least one processor, automatically generating predicted supervisory control suggestions for a plurality of supervisory setpoints associated with the system. As explained earlier, with respect to FIGS. 1-9, various techniques and components may be used for performing this step. Processor(s) 802 may execute instructions corresponding to the various components required to perform this step.

In conclusion the present disclosure relates to a system, including at least one processor, where the system is configured to using a measurable attribute associated with a system, segment operational data associated with the system into at least a first bin and a second bin. The system may further be configured to train a first brain based on a first data model associated with the first bin and train a second brain based on a second data model associated with the second bin. The system may further be configured to using the first brain and the second brain, implemented by at least one processor, automatically generate predicted supervisory control suggestions for a plurality of supervisory setpoints associated with the system.

The system may further be configured to determine a transition boundary between the first bin and the second bin as part of segmenting the operational data associated with the system into the first bin and the second bin. Each of the first brain and the second brain may be trained using a Markov decision process model characterized by a tuple comprising: (1) a finite set of states associated with the system, (2) a finite set of actions associated with the system, (3) a state transition function associated with the system, and (4) a reward function associated with the system. Neither the finite set of states associated with the system nor the finite set of actions associated with the system may include the measurable attribute associated with the system.

The transition boundary may relate to a transition in predicted values of at least one state associated with the system. The transition in the predicted values of the at least one state may be determined by a first set of training data corresponding to a forward data model and a second set of training data corresponding to a backward data model, where the forward data model relates to a dynamic behavior of the system forward in time and the backward data model relates to a dynamic behavior of the system backward in time.

In another example, the present disclosure relates to a method including using a measurable attribute associated with a system, segmenting operational data associated with the system into at least a first bin and a second bin. The method may further include training a first brain based on a first data model associated with the first bin and training a second brain based on a second data model associated with the second bin. The method may further include using the first brain and the second brain, implemented by at least one processor, automatically generating predicted supervisory control suggestions for a plurality of supervisory setpoints associated with the system.

The segmenting the operational data associated with the system into the first bin and the second bin further comprises determining a transition boundary between the first bin and the second bin. Each of the first brain and the second brain may be trained using a Markov decision process model characterized by a tuple comprising: (1) a finite set of states associated with the system, (2) a finite set of actions associated with the system, (3) a state transition function associated with the system, and (4) a reward function associated with the system. Neither the finite set of states associated with the system nor the finite set of actions associated with the system may include the measurable attribute associated with the system.

The transition boundary may relate to a transition in predicted values of at least one state associated with the system. The transition in the predicted values of the at least one state may be determined by using a first set of training data corresponding to a forward data model and a second set of training data corresponding to a backward data model, where the forward data model relates to a dynamic behavior of the system forward in time and the backward data model relates to a dynamic behavior of the system backward in time. The transition in the predicted values of the at least one state may be determined by determining differences between a first set of predicted values of the at least one state based on the forward data model and a second set of predicted values of the at least one state based on the backward data model.

The system may comprise a heating, ventilation, and cooling (HVAC) system and where the measurable attribute comprises an air temperature outside a structure being heated or cooled by the HVAC system.

In yet another example, the present disclosure relates to a method including using a measurable attribute associated with a system, segmenting operational data associated with the system into at least a first bin and a second bin, where the segmenting the operational data associated with the system into the first bin and the second bin further comprises determining a transition boundary between the first bin and the second bin. The method may further include using deep reinforcement learning, training a first brain based on a first data model associated with the first bin and training a second brain based on a second data model associated with the second bin. The method may further include using the first brain and the second brain, implemented by at least one processor, automatically generating predicted supervisory control suggestions for a plurality of supervisory setpoints associated with the system.

Each of the first brain and the second brain may be trained using a Markov decision process model characterized by a tuple comprising: (1) a finite set of states associated with the system, (2) a finite set of actions associated with the system, (3) a state transition function associated with the system, and (4) a reward function associated with the system. Neither the finite set of states associated with the system nor the finite set of actions associated with the system may include the measurable attribute associated with the system.

The transition in the predicted values of the at least one state may be determined by using a first set of training data corresponding to a forward data model and a second set of training data corresponding to a backward data model, where the forward data model relates to a dynamic behavior of the system forward in time and the backward data model relates to a dynamic behavior of the system backward in time. The transition in the predicted values of the at least one state may be determined by determining differences between a first set of predicted values of the at least one state based on the forward data model and a second set of predicted values of the at least one state based on the backward data model.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Exemplary transmission media include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A system, including at least one processor, the system configured to:
using a measurable attribute associated with a system, segment operational data associated with the system into at least a first bin and a second bin;
train a first brain based on a first data model associated with the first bin and train a second brain based on a second data model associated with the second bin; and
using the first brain and the second brain, implemented by at least one processor, automatically generate predicted supervisory control suggestions for a plurality of supervisory setpoints associated with the system.

2. The system of claim 1, further configured to determine a transition boundary between the first bin and the second bin as part of segmenting the operational data associated with the system into the first bin and the second bin.

3. The system of claim 1, wherein each of the first brain and the second brain is trained using a Markov decision process model characterized by a tuple comprising: (1) a finite set of states associated with the system, (2) a finite set of actions associated with the system, (3) a state transition function associated with the system, and (4) a reward function associated with the system.

4. The system of claim 3, wherein neither the finite set of states associated with the system nor the finite set of actions associated with the system include the measurable attribute associated with the system.

5. The system of claim 2, wherein the transition boundary relates to a transition in predicted values of at least one state associated with the system.

6. The system of claim 5, wherein the transition in the predicted values of the at least one state is determined by a first set of training data corresponding to a forward data model and a second set of training data corresponding to a backward data model, wherein the forward data model relates to a dynamic behavior of the system forward in time and the backward data model relates to a dynamic behavior of the system backward in time.

7. A method comprising:
using a measurable attribute associated with a system, segmenting operational data associated with the system into at least a first bin and a second bin;
training a first brain based on a first data model associated with the first bin and training a second brain based on a second data model associated with the second bin; and
using the first brain and the second brain, implemented by at least one processor, automatically generating predicted supervisory control suggestions for a plurality of supervisory setpoints associated with the system.

8. The method of claim 7, wherein the segmenting the operational data associated with the system into the first bin and the second bin further comprises determining a transition boundary between the first bin and the second bin.

9. The method of claim 7, wherein each of the first brain and the second brain is trained using a Markov decision process model characterized by a tuple comprising: (1) a finite set of states associated with the system, (2) a finite set of actions associated with the system, (3) a state transition function associated with the system, and (4) a reward function associated with the system.

10. The method of claim 9, wherein neither the finite set of states associated with the system nor the finite set of actions associated with the system include the measurable attribute associated with the system.

11. The method of claim 8, wherein the transition boundary relates to a transition in predicted values of at least one state associated with the system.

12. The method of claim 11, wherein the transition in the predicted values of the at least one state is determined by using a first set of training data corresponding to a forward data model and a second set of training data corresponding to a backward data model, wherein the forward data model relates to a dynamic behavior of the system forward in time and the backward data model relates to a dynamic behavior of the system backward in time.

13. The method of claim 12, wherein the transition in the predicted values of the at least one state is determined by determining differences between a first set of predicted values of the at least one state based on the forward data model and a second set of predicted values of the at least one state based on the backward data model.

14. The method of claim 7, wherein the system comprises a heating, ventilation, and cooling (HVAC) system and wherein the measurable attribute comprises an air temperature outside a structure being heated or cooled by the HVAC system.

15. A method comprising:
using a measurable attribute associated with a system, segmenting operational data associated with the system into at least a first bin and a second bin, wherein the segmenting the operational data associated with the system into the first bin and the second bin further comprises determining a transition boundary between the first bin and the second bin;
using deep reinforcement learning, training a first brain based on a first data model associated with the first bin and training a second brain based on a second data model associated with the second bin; and
using the first brain and the second brain, implemented by at least one processor, automatically generating predicted supervisory control suggestions for a plurality of supervisory setpoints associated with the system.

16. The method of claim 15, wherein each of the first brain and the second brain is trained using a Markov decision process model characterized by a tuple comprising: (1) a finite set of states associated with the system, (2) a finite set of actions associated with the system, (3) a state transition function associated with the system, and (4) a reward function associated with the system.

17. The method of claim 17, wherein neither the finite set of states associated with the system nor the finite set of actions associated with the system include the measurable attribute associated with the system.

18. The method of claim 15, wherein the transition boundary relates to a transition in predicted values of at least one state associated with the system.

19. The method of claim 18, wherein the transition in the predicted values of the at least one state is determined by using a first set of training data corresponding to a forward data model and a second set of training data corresponding to a backward data model, wherein the forward data model relates to a dynamic behavior of the system forward in time and the backward data model relates to a dynamic behavior of the system backward in time.

20. The method of claim 19, wherein the transition in the predicted values of the at least one state is determined by determining differences between a first set of predicted values of the at least one state based on the forward data model and a second set of predicted values of the at least one state based on the backward data model.
